(19) United States
(12) Patent Application Publication
(10) Pub. No.: US 2007/0153497 A1
(43) Pub. Date: Jul. 5, 2007

(54) LIGHTING ORNAMENT

(76) Inventor: Mo-Hsin Chang, Hsin Shi Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/306,620

(22) Filed: Jan. 4, 2006

(51) Int. Cl. F21V 21/08

(52) U.S. Cl. 362/103; 362/806; 362/605

(57) ABSTRACT

A lighting ornament includes an ornament body and a lighting device. The ornament body includes a front side and a rear side. The front side includes a light-transmittable section, and the rear side includes a compartment. The lighting device is mounted in the compartment of the rear side of the ornament body. The lighting device includes at least one lighting element that can be turned on when desired. Light beams emitted from the lighting element radiate outward after passing through the light-transmittable section.

### BACKGROUND OF THE INVENTION

1. Field of the Invention

The present invention relates to an ornament, and more particularly to a personal ornament such as a necklace, bracelet, bangle, pin, hairclip, barrette, earring, eardrop, key ring, or other pendants.

2. Description of the Related Art

People often wear personal ornaments such as necklaces, bracelets, bangles, pins, hairclips, barrettes, earrings, eardrops, key rings, or other pendants when going out. These ornaments provide static visual effect only and thus could not have people's more attention, which is particularly true in the night, for these ornaments could not provide any lighting or sounding effect.

### BRIEF SUMMARY OF THE INVENTION

A lighting ornament in accordance with the present invention comprises an ornament body and a lighting device. The ornament body comprises a front side and a rear side. The front side comprises a light-transmittable section, and the rear side comprises a compartment. The lighting device is mounted in the compartment of the rear side of the ornament body. The lighting device comprises at least one lighting element, means for supplying electricity to the at least one lighting element, and means for controlling on/off of the at least one lighting element. Light beams emitted from the at least one lighting element radiate outward after passing through the light-transmittable section.

Preferably, the lighting ornament further comprises a casing mounted in the compartment of the ornament body. A battery box is mounted in the casing and receives the means for supplying electricity to the at least one lighting element.

Preferably, the battery box is slidable between a conductive position and a non-conductive position. The at least one lighting element is turned on when the battery box is in the conductive position, and the at least one lighting element is turned off when the battery box is in the non-conductive position.

Preferably, the casing comprises a receiving space for receiving the battery box. Each of two lateral walls delimiting the receiving space comprises a guiding groove. The battery box comprises two lateral sides each including a guiding rib slidably received in an associated guiding groove of the casing.

Preferably, each guiding groove of the casing comprises a positioning portion. Each guiding rib of the battery box comprises a positioning portion for engaging with the positioning portion of an associated guiding groove of the casing to prevent the battery box from disengaging from the casing.

Preferably, the means of supplying electricity to the at least one lighting element comprises two cells connected in parallel, a conductive plate, and a substrate having two contacts. A positive pole of one of the cells and a negative pole of the other cell are in contact with the conductive plate. A negative pole of the cell and a positive pole of the other cell are in contact with the contacts on the substrate when the battery box is in the conductive position. The negative pole of the cell and the positive pole of the other cell are not in contact with the contacts on the substrate when the battery box is in the non-conductive position.

Preferably, the lighting device further comprises a buzzer.

The light-transmittable section may be a cover that is removably mounted to the front side of the ornament body. Preferably, the cover is made of light-transmittable material. Alternatively, the cover comprises a plurality of through-holes to form the light-transmittable section.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a lighting ornament in accordance with the present invention.

FIG. 2 is an exploded perspective view of the lighting ornament in accordance with the present invention.

FIG. 3 is an elevational view of the lighting ornament in accordance with the present invention.

FIG. 4 is a sectional view taken along plane 4-4 in FIG. 3.

FIG. 5 is a view similar to FIG. 3, wherein the lighting ornament is turned on.

FIG. 6 is a sectional view taken along plane in FIG. 5.

FIG. 7 is a perspective view illustrating use of the lighting ornament as a part of a necklace.

FIG. 8 is a perspective view illustrating use of the lighting ornament as a part of a bracelet.

FIG. 9 is a perspective view illustrating incorporation of the lighting ornament into a barrette.

### DETAILED DESCRIPTION OF THE INVENTION

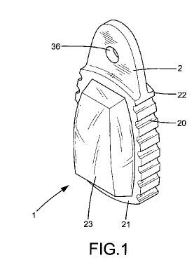

Referring to FIG. 1, a lighting ornament in accordance with the present invention comprises an ornament body 2 and a lighting device 3 mounted inside the ornament body 2. The ornament body 2 may have any shape according to the wearer's choice and may comprise patterns 20 or the like on a perimeter thereof for ornamental purposes.

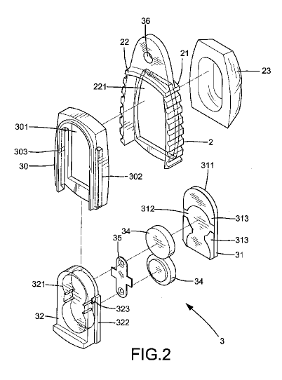

Referring to FIGS. 2 through 4, the ornament body 2 in the illustrated embodiment comprises a front side 21 and a rear side 22. The rear side 22 includes a compartment 221 for receiving the lighting element 3. The front side 21 includes a light-transmittable section 23 that is integrally formed with or separate from the ornament body 2. In this embodiment, the light-transmittable section 23 is a separate cover removably mounted to the front side 21 of the ornament body 2. Preferably, the cover is made of light-transmittable material. Alternatively, the cover includes through-holes to form a light-transmittable section allowing passage of light beams from the lighting device 3.

The lighting device 3 comprises at least one lighting element 33. In this embodiment, the lighting element 33 is a light-emitting diode. The lighting element 33 is mounted on a first face 311 of a substrate 31 that faces the light-transmittable section 23. The substrate 31 is mounted in a casing 30, which, in turn, is mounted in the compartment 221 of the ornament body 2. The substrate 31 is thus fixed in the rear side 22 of the ornament body 2.

The lighting device 3 further comprises at least one cell 34 to provide electricity to the circuitry on the substrate 31 and the lighting element 33. In this embodiment, two cells 34 are mounted in a cell chamber 321 of a battery box 32 and electrically connected in parallel. A conductive plate 35 is mounted in the battery box 32 and in contact with a positive pole (not labeled) of one of the cells 34 and a negative pole (not labeled) of the other cell 34.

The lighting device 3 further comprises a switch for controlling on/off of the lighting element 33. In this embodiment, the switch includes two separate contacts 313 on a second face 312 of the substrate 31. When a positive pole and a negative pole respectively of the cells 34 come in contact with the contacts 33, the lighting element 33 is turned on. On the other hand, when the above-mentioned positive pole and the above-mentioned negative pole respectively the cells 34 are not in contact with the contacts 33, the lighting element 33 is turned off.

In this embodiment, on/off of the lighting element 33 is controlled by the position of the battery box 32. The casing 30 includes a receiving space 301 for receiving the battery box 32. Each of two lateral walls delimiting the receiving space 301 includes a guiding groove 302. Each of two lateral sides of the battery box 32 includes a guiding rib 322 slidably received in an associated one of the guiding grooves 302. Sliding movement of the battery box 32 in the casing 30 is used to control on/off of the lighting element 33. Further, each guiding groove 302 of the casing 30 may include a positioning portion 303 (in the form of a recessed portion in the illustrated embodiment), and each guiding rib 323 of the battery box 32 may include a positioning portion 323 (in the form of a protrusion in the illustrated embodiment) for coupling with the associated positioning portion 303 on the casing 30, preventing the battery box 32 from disengaging from the casing 30.

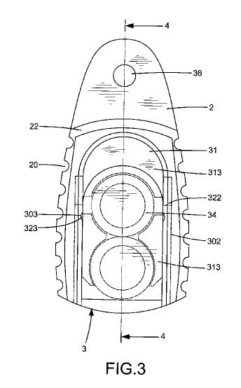

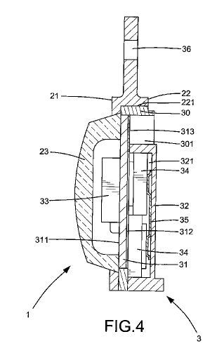

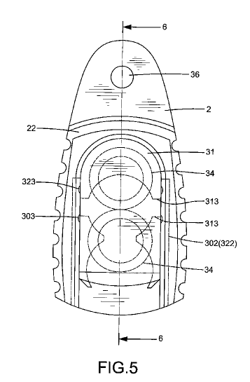

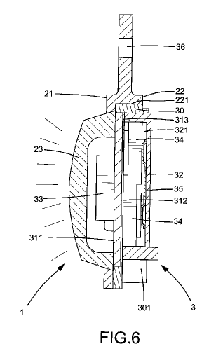

Referring to FIGS. 3 and 4, after assembly, when the battery box 32 is in a non-conductive position, the poles of the cells 34 facing the substrate 31 are not in contact with the contacts 313 of the substrate 31, the lighting element 33 does not illuminate. Referring to FIGS. 5 and 6, when the battery box 32 is moved to a conductive position in which the poles of the cells 34 facing the substrate 31 are in contact with the contacts 313 of the substrate 31, the lighting element 33 is turned on. The light beams from the lighting element 33 radiate outward through the light-transmittable section 23 of the ornament body 2, providing a conspicuous effect. The lighting element 33 may flicker or remain lit. This provides an alarm effect when the wearer walks in the night.

The ornament lighting 1 in accordance with the present invention can be combined with or incorporated into any personal ornament such as a necklace, bracelet, bangle, pin, hairclip, barrette, earring, eardrop, key ring, or other pendants.

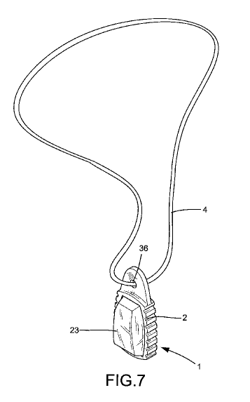

Referring to FIG. 7, a chain 4 or the like is extended through a through-hole 36 in an end of the ornament body 2 to form a necklace with lighting effect.

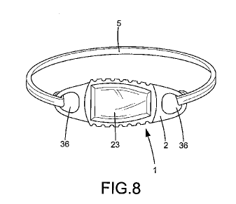

Referring to FIG. 8, a through-hole 36 is provided in each of two ends of the ornament body 2 for coupling with an associated end of a bracelet 5. Hence, the lighting element 1 can be coupled with and thus form a part of the bracelet 5. A bracelet 5 with lighting effect is thus obtained.

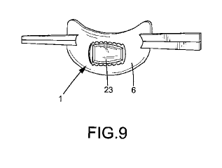

Referring to FIG. 9, the lighting ornament 1 can be fixed on a barrette 6 to provide lighting effect.

The lighting device 3 may further comprise a buzzer for providing alarm effect or amusement effect. The casing 30 may be fixed to the ornament body 2 in any suitable way. Further, more than one lighting ornament 1 in accordance with the present invention can be mounted on or incorporated into a personal ornament.

Although specific embodiments have been illustrated and described, numerous modifications and variations are still possible without departing from the essence of the invention. The scope of the invention is limited by the accompanying claims.

What is claimed is:

1. A lighting ornament comprising:
an ornament body comprising a front side and a rear side, the front side comprising a light-transmittable section, the rear side comprising a compartment; and
a lighting device mounted in the compartment of the rear side of the ornament body, the lighting device comprising at least one lighting element, means for supplying electricity to said at least one lighting element, and means for controlling on/off of said at least one lighting element;
light beams emitted from said at least one lighting element radiating outward after passing through the light-transmittable section.

2. The lighting ornament as claimed in claim 1, with the lighting ornament further comprising a casing mounted in the compartment of the ornament body, a battery box being mounted in the casing and receiving said means for supplying electricity to said at least one lighting element.

3. The lighting ornament as claimed in claim 2, with the battery box being slidable between a conductive position and a non-conductive position, said at least one lighting element being turned on when the battery box is in the conductive position, and said at least one lighting element being turned off when the battery box is in the non-conductive position.

4. The lighting ornament as claimed in claim 3, with the casing comprising a receiving space for receiving the battery box, each of two lateral walls delimiting the receiving space comprising a guiding groove, the battery box comprising two lateral sides each including a guiding rib slidably received in an associated one of the guiding grooves of the casing.

5. The lighting ornament as claimed in claim 4, with each said guiding groove of the casing comprising a positioning portion, each said guiding rib of the battery box comprising a positioning portion for engaging with the positioning portion of an associated one of the guiding grooves of the casing to prevent the battery box from disengaging from the casing.

6. The lighting ornament as claimed in claim 3, with said means of supplying electricity to said at least one lighting element comprising two cells connected in parallel, a conductive plate, and a substrate having two contacts, with a positive pole of one of the cells and a negative pole of the other cell being in contact with the conductive plate, with a negative pole of said one of the cells and a positive pole of the other cell being in contact with the contacts on the substrate when the battery box is in the conductive position, and with the negative pole of said one of the cells and the positive pole of the other cell being not in contact with the contacts on the substrate when the battery box is in the non-conductive position.

7. The lighting ornament as claimed in claim 1, with the lighting device further comprising a buzzer.

8. The lighting ornament as claimed in claim 1, with the light-transmittable section being a cover that is removably mounted to the front side of the ornament body.

9. The lighting ornament as claimed in claim 8, with the cover being made of light-transmittable material.

10. The lighting ornament as claimed in claim 8, with the cover comprising a plurality of through-holes to form the light-transmittable section.
